(19) United States
(12) Patent Application Publication
(10) Pub. No.: US 2005/0180406 A1
(43) Pub. Date: Aug. 18, 2005

(54) Internet VoIP chat cord apparatus

(76) Inventor: Ovadia Sagiv, Ganot (IL)

Correspondence Address: Barber Legal, PO Box 16220, Golden, CO, 80402-6004, US

(21) Appl. No.: 10/780,528

(22) Filed: Feb. 18, 2004

(51) Int. Cl. H04L 12/28

(52) U.S. Cl. 370/353; 370/401

(57) ABSTRACT

A hardware device having software installed in a personal computer converting analog voice information to digital voice and connecting a cordless telephone or regular telephone to a personal computer routed through the Internet via Internet Protocol addressing. Calls may be placed via the linked Internet chat cord invention using a cordless telephone or a regular phone and through a personal computer connected to the Internet. Calls may be received via the Internet to a personal computer and then to a cordless or regular phone via Voice over Internet Protocol using the Internet chat cord. Telephone conversations may also be placed to more than one personal computer and/or PSTN telephone at the same time providing conferencing.

### FIELD OF THE INVENTION

This invention relates generally to personal computers and specifically to the use of software and hardware attachments to complete PC to PC and PC to a remote telephone for voice communication from a telephone via Voice over Internet Protocol.

### CROSS-REFERENCE TO RELATED APPLICATIONS

N/A

### STATEMENT REGARDING FEDERALLY FUNDED RESEARCH

This invention was not made under contract with an agency of the US Government, nor by any agency of the US Government.

### BACKGROUND OF THE INVENTION

The phone customer has several choices for local and long distance phone service. The newest offering for phone service involves the use of Voice over Internet Protocol (VoIP) via a long distance Internet telephone company (LDITC). This allows a subscriber to talk from their PC to another subscriber at their PC or a standard telephone that is connected to the LDITC network.

Standard issue for PCs to the consumer includes a pair of speakers as well as a small microphone. Although phone calls can be made from a PC directly connected to the traditional Public Switched Telephone Network (PSTN), local and long distance fees are collected by the local or long distance carrier, which may not be a long distance Internet telephone company. The development of Voice over Internet Protocol competes with a Public Switched Telephone Network whose system may become over loaded with more phone calls that it can handle. VoIP provides call service using a unique twelve digit Internet Protocol number or address that is held by the user. Many major companies and banks forwarding or receiving information or wire transfers of money have relied heavily on the Internet Protocol numbering schemes in order to maintain their businesses, now voice callers can as well, using VoIP. This type of data communications has a greater capacity for moving information or phone calls than the traditional Public Switched Telephone Network also known as POTS (Plain Old Telephone Service).

The users placing a call via VoIP from their PC must have a subscription with a LDITC and know the twelve digit IP address number or name designation decided upon by the user and the LDITC, of the individual they wish to speak. The user's words are picked up by a microphone on the user's PC which is connected by a mini-jack to a sound card. The sound card and the appropriate software convert the sounds to a set of zeros and ones, which are digital data packets used in Internet Protocol messaging. This digital information is transmitted by the Internet using the twelve digit IP address of the receiver at his/her PC. The sound card at the receiving end is used to convert the digital data packets back into audio speaker output allowing two-way conversation.

In general, making such connections is difficult. The user must activate VoIP software and then enter sufficient information to allow the software to make a successful VoIP connection to another VoIP user. Thus, while VoIP is a free service or the closest thing to free, it is NOT as convenient as picking up a telephone and dialing. The easy and familiar use of the telephone has been lost.

Various items of prior art may be considered.

U.S. Patent publication No. US 2003/0032393 published Feb. 13, 2003 in the names of Kennedy et al and entitled PERSONAL COMPUTER PHONE PATCH teaches an external adapter box, PCPP, used to connect a telephone to the sound card of the computer. FIG. 3 shows clearly that PCPP needs external mains power (although later the claim is made that it does not). Also FIG. 3 discloses that this needs the PC keyboard to switch to PSTN. PCPP commands calling actions by hardware rather than via a resident program in the PC.

U.S. Patent publication No. US 2002/0097862 published Jul. 25, 2002 in the names of Shvadron and entitled VODSL TELEPHONE SOLUTION deals with connection of telephone equipment to an adapter communicating digitally with a control device connected to the existing telephone wiring. The invention employs DSL (Digital Subscriber Loop) for voice communication.

U.S. Pat. No. 6,404,764 to Jones et al issued Jun. 11, 2002, for VOICE OVER INTER PORTOCOL TELEPHONE SYSTEM AND METHOD is typical in requiring special equipment in order to provide VoIP to users of apparently normal PSTN/POTS telephones: it uses a dedicated internet device to provide VoIP. Network Premises Gateway is an item of hardware used to provide the desired functionality. There is no teaching that a hookup of the sound card/RJ-11/telephone may be utilized, nor apparently teaching that the PC may be used in a passive role, nor apparently teaching that the PC may be consequently commanded by the telephone via dedicated software.

U.S. Pat. No. 6,345,047 issued Feb. 5, 2002 to Regnier for COMPUTER TELEPHONY ADAPTER AND METHOD teaches a system allowing simultaneous use of a single telephone line's bandwidth for both a PSTN telephone call and the use of IP packets. It is otherwise a fairly normal VoIP system, envisioning use of a headset/microphone/speaker system and a hub to connect a telephone to a computer.

U.S. Pat. No. 6,560,660 issued May 6, 2003 to Flanagin for FACILITY COMMUNICATIONS PORT SHARING teaches communication via serial port, monitoring the port to detect when a peripheral device is detected and whether the device is of the appropriate type for use by a software package. It does not relate to use of the sound card/RJ-11/telephone for telephonic VoIP communications.

U.S. Pat. No. 5,815,682 issued Sep. 29, 1998 to Williams et al for DEVICE INDEPENDENT MODEM INTERFACE teaches a modem interface independent of device, and does not directly deal with VoIP and thus is not in the same art field.

U.S. Pat. No. 6,445,789 issued Sep. 3, 2002 to Hirano et al for TELEPHONE HAVING HAND-SET TO BE USED ALSO AS VOICE INPUT/OUTPUT DEVICE FOR PERSONAL COMPUTER teaches a telephone device with a hand-set accessory that may be connected to a voice input/output for the personal computer, to the voice input/output interface for the computer network.

Yet another device using an external box to connect a telephone to a PC sound card is taught at www.phonebridge.com. It is a junction box which uses external mains power, doesn't have any detection of DTMF and doesn't provide switching to the PSTN of the same phone-set.

Other devices use the USB slot of a computer for such connections, information on the USB devices may be found at, http://www.pcphoneline.com/, http://www.amegroup.com/ipo11.htm, (A USB VoIP device connecting phone device to PC via USB port and not a Voice Card. It uses powerful Digital Signal Processor (DSP) to run the interface phone-PC. Its DTMF is derived from hardware and not by software.) Also, http://www.ipmental.com.tw/en/products-service/taichi2.htm, http://www.amegroup.com.au/ipo11.html, http://www.tinet.com/solutions/usb_phone.htm, http://www.cuphone.com/. http://www/pcphoneline.com/ and www.1internet-phone.com and www.edcwireless.com. All such devices teach the use of a USB port for audio/voice input and output and thus teach firmly away from use of older types of ports, which are occasionally denigrated as being “legacy ports”.

It would be advantageous to have a device providing PC to PC or PC to a remote telephone for voice communication via a cordless telephone or regular phone with conferencing abilities using Voice over Internet Protocol and/or Public Switched Telephone Network.

### SUMMARY OF THE INVENTION

General Summary

The present invention teaches a hardware device having optional software installed in a personal computer converting analog voice information to digital voice and connecting a cordless telephone or regular telephone to a personal computer routed through the Internet via Internet Protocol addressing. Calls may be placed via the linked Internet chat cord invention using a cordless telephone or a regular phone and through a personal computer connected to the Internet. Calls may be received via the Internet to a personal computer and then to a cordless or regular phone via Voice over Internet Protocol using the Internet chat cord. Telephone conversations may also be placed to more than one personal computer and/or PSTN telephone at the same time providing conferencing.

Software modules in the PC cooperate with hardware modules in the Internet chat conversion cord device to allow the telephone user to actually use the telephone as an ordinary telephone and yet receive actual VoIP service. The hardware modules in the Internet conversion cord provide proper conversion of electrical signals, while the software modules provide control and importantly, allow for easy conversion of DTMF tones to VoIP usable addressing.

Summary in Reference to Claims

It is therefore a first aspect, objective, advantage and embodiment of the present invention to provide a computer audio input/output device comprising: a personal computer having an operating system and a full duplex voice sound card; the sound card having a first standard mini-jack input, and having a second standard mini-jack output; a first software device respectively providing audio input and output to the respective first and second jacks; an electronic interface unit having, at least two standard mini-jack plugs, and a standard telephone jack plug; a second software device responsive to inputs commanded by the telephone via the electronic interface device; a signal conversion circuit connecting a voice signal from the standard telephone jack to the input mini-jack, and connecting an audio signal from the output mini-jack to the standard telephone jack plug.

It is one aspect, advantage, embodiment and objective of the present invention to provide a Voice over Internet Protocol device comprising a personal computer having an operating system, any Serial Bus port such as USB or PS2, an internet connection, and a full duplex voice sound card. The sound card having a first standard mini-jack input, and having a second standard mini-jack output and a first software device providing audio input and output to the respective first and second jacks, a second software device having a Voice over Internet Protocol production module, and a Voice over Internet Protocol reception module, an electronic interface unit having a Serial Bus port such as USB or PS2, at least two standard mini-jack plugs, and a STANDARD TELEPHONE JACK plug, a conversion circuit on the electronic interface unit connecting an electricity power signal from the computer's Serial Bus port to the STANDARD TELEPHONE JACK plug, and connecting a caller's voice signal on the STANDARD TELEPHONE JACK to the input mini-jack, and connecting the callers audio signal from the output mini-jack to the standard telephone jack plug.

It is a another aspect, advantage, embodiment and objective of the present invention to provide telephone conferencing between Voice over Internet Protocol phone connections and Public Switched Telephone Network phone connections.

It is yet another aspect, advantage, embodiment and objective of the present invention to provide a Voice over Internet Protocol device comprising: a personal computer having an operating system, Serial Bus port, an internet connection, and a full duplex voice sound card; the sound card having a first standard mini-jack input, and having a second standard mini-jack output; a first software device respectively providing audio input and output to the respective first and second jacks; a second software device having a Voice over Internet Protocol production module to the Internet via the Internet connection, and a Voice over Internet Protocol reception module from the Internet via the Internet connection; an electronic interface unit having a Serial Bus port such as USB or PS2, at least two standard mini-jack plugs, and an standard telephone jack plug; a power conversion circuit on the electronic interface unit connecting an electrical power signal from the computer's Serial Bus port to the standard telephone jack plug, and a signal conversion circuit connecting a voice signal from the standard telephone jack to the input mini-jack, and connecting an audio signal from the output mini-jack to the standard telephone jack plug.

It is yet another aspect, advantage, embodiment and objective of the present invention to provide a Voice over Internet Protocol device further comprising an application program; the application program having a software database of VoIP addresses and telephone numbers, the application program having a communications port monitoring module able to open a duplex voice over internet protocol connection to the internet and able to open a duplex voice connection to a Public Switched Telephone Network, the application program having a detection module able to process a DTMF connection request of a device attached to the standard telephone jack to a selected address.

It is yet another aspect, advantage, embodiment and objective of the present invention to provide a Voice over Internet Protocol device wherein the electronic interface unit further comprises an Electrical Magnetic Interference/Radio Frequency Interference (EMI/RFI) suppression module that protects the interface unit and Personal Computer from EMI/RFI noise from the environment in both radiated and conducted modes.

It is yet another aspect, advantage, embodiment and objective of the present invention to provide a Voice over Internet Protocol device wherein the electronic interface unit further comprises a power limit module; a power limit module providing protection to the electronic interface unit and personal computer from any voltage above 6.5 Vdc.

It is yet another aspect, advantage, embodiment and objective of the present invention to provide a Voice over Internet Protocol device wherein the electronic interface unit further comprises a coupler module; a coupler module providing a bidirectional signal split of unidirectional signals of the speaker and microphone jacks of the sound card of the computer, the coupler module's electronic circuit following the formula, Vmic=Vr-t−Vspk−Vdc and Vr-t=Vring−Vtip=Vrx+Vtx+Vdc and wherein; Vtx=Vspeaker=Vspk, Vrx=Vmicrophone=Vmic, Vdc=5Vdc.

It is yet another aspect, advantage, embodiment and objective of the present invention to provide a Voice over Internet Protocol device wherein the electronic interface module further comprises a selector module; the selector module including a DTMF detector, a ringer, and a three position switch, wherein in the first position, the telephone is connected to the computer for VoIP communications; and wherein in the second position, the telephone is connected to a PSTN service; and wherein in the third position, the telephone is connected to both the PSTN service and the computer for conference calling spanning both PSTN service and VoIP service.

It is yet another aspect, advantage, embodiment and objective of the present invention to provide a Voice over Internet Protocol device wherein the switch further comprises a DTMF detector able to receive DTMF codes from the standard telephone jack and alter the position of the switch in response to such DTMF codes.

It is yet another aspect, advantage, embodiment and objective of the present invention to provide a Voice over Internet Protocol device wherein the selector module further includes a database of telephone numbers in the database, indicating whether VoIP or PSTN is the preferred communication route for a given telephone number.

It is yet another aspect, advantage, embodiment and objective of the present invention to provide a Voice over Internet Protocol device further comprising a POTS telephone with typical 600 ohms impedance.

And it is one more aspect, advantage, embodiment and objective of the present invention to provide a Voice over Internet Protocol device wherein the a detection module carries out the following steps: 1) Use sound card to track audio stream input from the electronic interface unit; 2) Form a first array of buffers with the audio stream in the form of a complex number representing Frequency and Volume; 3) Perform a Fast Fourier Transform on each buffer in the first array and use the product to fill a corresponding buffer in a second array; 4) Select products at least equal to a predefined threshold value; 5) Screen the selected products for two maximum values; 6) Associate the two maximum product values with the DTMF digit corresponding to the frequency combination of the two maximum product values, repeating steps 5 and 6 until such association is made; 7) Raise an event to the application program.

It is yet another aspect, advantage, embodiment and objective of the present invention to provide a computer system comprising: a PC having a full duplex voice card and having a USB or PS2 port and an operating system and a communication port; an operative physical connection from the PC communication port to a cordless telephone; an application program within such PC having a module to provide operative communication to the cordless telephone, and having a module to control communications and dialing of the telephone; a computer network connection; wherein the application program has a monitoring module responsive upon receiving a communication request from the telephone to open a duplex voice connection of the telephone to the network.

It is yet another aspect, advantage, embodiment and objective of the present invention to provide a computer system wherein the operative physical connection further comprises a standard telephone jack at one end and a microphone jack and a speaker jack at the other end, the telephone being plugged into the standard telephone jack and the microphone and speaker jacks being plugged into the computer's sound card, the respective jacks being in a tuned connection.

It is yet another aspect, advantage, embodiment and objective of the present invention to provide a computer system wherein the monitoring module further comprises a database of VOIP and PSTN addresses, and wherein the monitoring ;module further comprises a DTMF detection module, the database being responsive to the DTMF detection module.

It is yet another aspect, advantage, embodiment and objective of the present invention to provide a computer system wherein the application program further comprises a network monitoring module able to monitor the network connection and indicate reception of an incoming VOIP communication from the network, the indication being made at one member selected from the group consisting of: the PC, the telephone, and combinations thereof.

It is yet another aspect, advantage, embodiment and objective of the present invention to provide a computer system wherein the application program further comprises a telephone service module providing at least one member from the group consisting of: prompting of callers, caller identification, message recording, ring status indicators, busy status indicators, no signal status indicators, error indicators, not on line indicator and combinations thereof.

It is yet another aspect, advantage, embodiment and objective of the present invention to provide a computer system wherein the application program further comprises a control module responsive to the DTMF detection module, the application program functioning being responsive to the control module.

It is yet another advantage, aspect, objective, and embodiment of the invention to provide a computer system wherein the DTMF detection module is further responsive to DTMF commands in which one of the DTMF frequencies is 1633 Hz.

It is yet another aspect, advantage, embodiment and objective of the present invention to provide a computer system wherein the operative connection further comprises: an operative connection to a PSTN telephone network, the operative connection having parallel connections to the PC and to the PSTN telephone network.

### BRIEF DESCRIPTION OF THE DRAWINGS

FIG. 1 is a block diagram showing connection of the Internet chat cord through the Internet.

FIG. 2 is a block diagram showing connection of the Internet chat cord and Internet Provider.

FIG. 3 is a block diagram of the Internet chat conversion cord internal circuitry

FIG. 4 is a block diagram of software participation as a voice signal travels to the Internet

FIG. 5 is a block diagram of the Selector Module embodiment of the invention.

FIG. 6 is a diagram of the Internet chat conversion cord

FIG. 7 is a diagram of PRIOR ART.

### INDEX TO REFERENCES NUMBERS

110 Cordless Telephone or Regular Phone
111 Electronic Interface Unit (Internet chat cord)
112 RJ-11 Plug to cordless Telephone
113 Serial Bus port such as USB or PS2
114 Input/Output Mini-jacks to Personal Computer
115 Personal Computer
116 Internet “Cloud”
210 Long Distance Internet Telephone Company (LDITC).
211 PC to PC Internet connection.
310 Public Switched Telephone Network
311 Selector Module
312 FirstTip
313 First Ring
314 Power Regulator Module
315 Electrical Magnetic Interference/Radio Frequency Interference Suppression Module
316 Power Limit Module
317 Second Tip
318 Second Ring
319 Microphone
320 Speaker
321 Universal Serial Bus or PS2 port
322 Sound Card
323 Coupler Module
410 Personal Computer Operating System
411 Physical Internet Connection
412 Sound Card—Phone, Application Program/invention installation software
413 Other PC Resources on Local Area Network
414 Digital Tone Multi-Frequency (DTMF)
510 Selector Circuit
511 Ring Generator
512 Protection Circuit
513 DTMF Detector and Decoder
610 Serial Bus port such as USB or PS2
611 Female Mini-Jack Plug
710 PhoneBridge
711 Microphone
712 Power Supply
713 Speakers
714 Microphone and Speaker Jacks

### DETAILED DESCRIPTION

In the presently preferred embodiment and best mode presently contemplated for carrying out the invention an electronic interface unit 111 and installation software 412 may provide telephone communication from a cordless or regular phone 110 using a computer 115 and Internet connection 210 via Voice over Internet Protocol (VoIP) Provider (PC to Phone) or just via the Internet connection 211 itself to make PC to PC call connection.

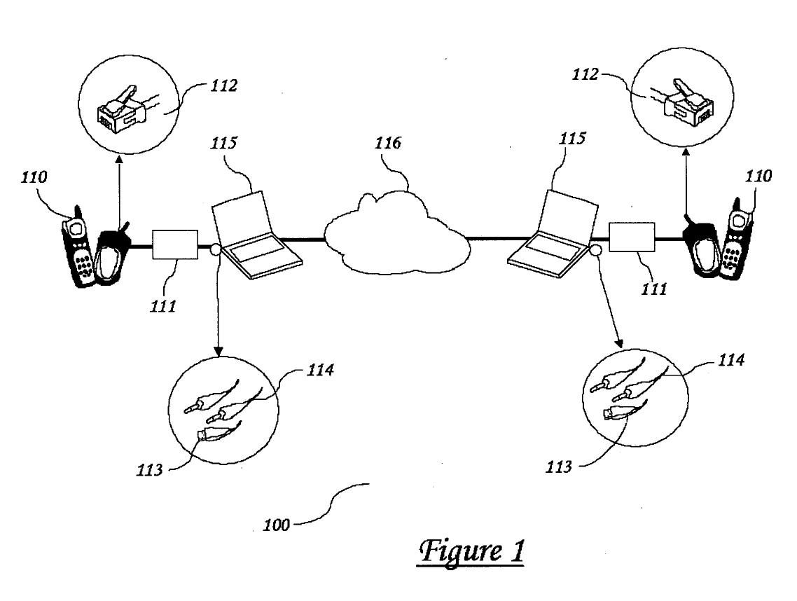

FIG. 1 is a block diagram that generally illustrates the path a voice signal takes as it travels from an originating caller to a receiver and back again. A cordless or regular phone 110 may be used to initiate a call. An RJ-11 plug 112 connected to the phone 110 from the electronic interface unit (Internet chat cord) 111 is shown connecting to a typical personal computer 115 via a Serial Bus port such as USB or PS2 113 and input/output mini-jacks 114. The input/output mini-jacks is also shown in close-up 114. An Internet connection places a digital voice signal into the Internet cloud 116 where the signal is conveyed via Voice over Internet Protocol (VoIP). Since the digital voice signal uses an Internet Protocol addressing scheme, the Internet can route the signal to the appropriate addressee reaching the computer 115 and attached phone 110 of an intended receiver. A 5 volt electric power signal is supplied from the computer's serial bus port 113 through the electronic interface unit (Internet chat cord) 111 and the RJ-11 plug 112 providing sufficient power to operate those cordless or regular phones 110 which need such assistance. Note that while the 5Vdc from the USB (or alternatively the PS2) port is utilized in the basic preferred embodiment, this connection is not necessarily present in alternative embodiments. The basic preferred embodiment does not need the USB/PS2 connection while still working with numerous types of cordless telephones, however the USB/PS2 connection is added to the preferred embodiment to enable proper operation with those telephone sets which do require the 5Vdc signal in order to open up their audio interface.

The USB port 5Vdc signal may also be used to power the alternative embodiments discussed below which may have a selector module allowing ringer, use of the same phone-set for call and switching between PSTN and VoIP call and also for conferencing by the user with two or more callers, one or more on a PSTN service and one or more on a VOIP service.

The overall computer system may also have a monitoring module having a database of VOIP and PSTN addresses. The monitoring module may further have a DTMF detection module, the database being responsive to the DTMF detection module. Thus, a user picking up the telephone and dialing a number will generate DTMF codes which will be converted in the operative connection (the Internet chat cord or electronic interface unit) to an electronic format acceptable to the computer, and the monitoring module of the application program will then convert this to a usable VoIP address, either associated with a PSTN address (i.e. a telephone number) or not. Note that in embodiments, the electronic interface device may itself have such a database, and when a number is dialed, the “chat” cord may make a similar decision (DTMF detection to database of numbers) as to whether the DTMF tones should be routed to the computer (for a VoIP call) or to the PSTN for a POTS call.

The application program also comprises an Internet monitoring module able to monitor the network connection and indicate reception of an incoming VoIP communication from the network, the indication being made at the PC, the telephone, or both. By this means, incoming calls may be received with equal convenience and ease.

In fact, further functions may be added: the application program may have an advanced telephone-like module which has an added column of 4 keys (just it or additional to the typical 3 columns of 4 keys in the normal telephone). This column will use the DTMF pair A, B, C, D (F2=1633 Hz) which do not exist in normal phones in order to perform special remote commands like operate a telecommanded unit such as a camera or an appliance, open a discrete device such as a faucet or a door, listen, record, play, and similar remote functions. A second software device may broadly be responsive to inputs commanded by the telephone via the electronic interface device. It may also be, as in the preferred embodiment, more specifically a VOIP connection, but it is not so limited.

In fact, further functions may be added: the application program may have an advanced telephone-service module which is able to provide prompting of callers, caller identification (Caller ID), message recording, ring status indicators, busy status indicators, no signal status indicators, error indicators, caller authentication and so on.

The application program provides even more convenience by having a control module responsive to the DTMF detection module, the application program functioning being responsive to the control module, so that all functions/operations of the application program, or a subset thereof, may be controlled by pushing buttons on the telephone rather than the PC. Obviously, the PC application program may be responsive to control by the user at the computer as well, and it may incorporate plug and play functionality, it may be self installing and other software convenience features as may be desired to be incorporated.

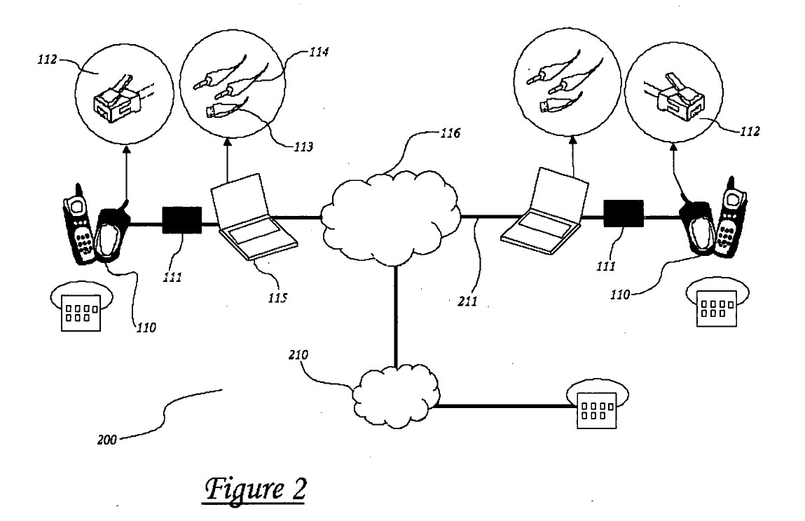

FIG. 2 illustrates in greater detail the components and connections the invention takes to complete a call. Cordless and regular phones 110 may be used to place a call. The RJ-11 plug 112 connects to the cordless or regular phone 110 from the Internet chat cord 111 which in turn is linked to a PC 115 via a USB or PS2 port 113 in the PC 115, that provides (in those embodiments which use this power source) 5Vdc power to the hand sets, and at least two mini-jacks 114 that are linked to the computers' 115 sound card 322. The computer 115 is linked to the Internet 116. The software of the invention 111 converts the named or telephone numbered address of the intended receiver to the appropriate Internet Protocol address prior to sending the digital voice information to the Internet 116. From the calling PC 115, the software and invention 111 may place calls to both another PC 115 and to a telephone 110 via Voice over Internet Protocol. A typical provider of VoIP is called a Long Distance Internet Telephone Company (LDITC) 210. The call placed from a computer 115, via the LDITC, arrives at the receive side PC 115 where the residing software of the invention 111 may convert the digital voice information to an analog voice signal and is routed via input/output mini-jacks through the Internet chat cord 111 circuitry. The USB plug provides 5Vdc power to the cordless or regular phone 110 and the voice signal continues through the RJ-11 plug 112 provided by the invention 111 completing the call.

In normal PSTN/POTS the telephone line interface has to provide two functions when it is off-hook.
1) Provide DC path for current flowing in the telephone line. Normally the current flowing in the telephone line is about 20-50 mA and telephone regulations typically specify that the DC resistance must be less than 400 ohms.
2) Provide proper termination for telephone audio frequencies (300-3400 Hz). This typically specified to be at 600 ohms impedance.

Thus, the interface device of the invention (the conversion cord) must be able to handle signals having these characteristics in both input and output to the signals generated in and needed by the sound card of the computer.

Internet chat cord 111 has or complies with the following POTS characteristics:

| | |
|---|---|
| Bandwidth | 300-3.3 kHz (3 kHz BW) |
| Signal-to-noise | 45 dB |
| Average Level | −9 dBm (275 mV) |
| | [0 dBm = 1 mW (0.775 V) into 600 ohms] |
| Impedance | 600 ohms |
| Connector | RJ-11 |
| Cable | 2-Wire |
| DC Voltage | 48 V (±6 V typ) |
| Polarity | Positive (tip, or red wire) |
| | tied to earth ground so it measures 48 Vdc |
| | (relative to ring or green wire) |
| DC Current | 20-26 mA (typ) |
| DC Resistance | 200-300 ohms (typ) |
| AC Ring Volts & Freq. | 90 Vrms, 20 Hz (2 secs on, 4 secs off) |

The Internet chat cord 111 electronic circuitry conforms to the above requirements since it interfaces with a normal standard PSTN/POTS telephone, whether cordless or regular, and it completes this process with its electrical circuit using the following modules:

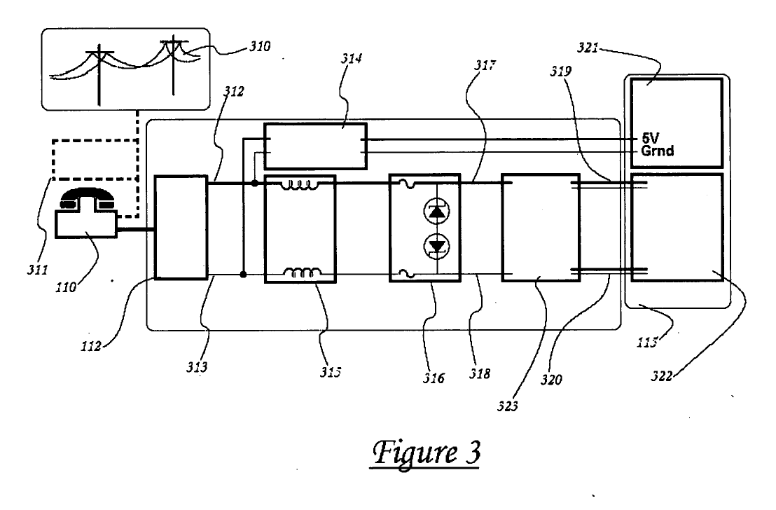

FIG. 3 is a block diagram of the electronic interface unit (Internet chat cord) 111. Following the diagram from left to right, Public Switched Telephone Network 310 accepts the incoming voice signal that may also be sent via the Internet 116. A selector module 311 may have a switch having a first and second position. In the first position DTMF (Digital Tone Multi-Frequency) codes generated by the telephone 110 by the caller are converted by the DTMF program 414 as necessary for the sound card, then directed to the full duplex sound card 322 and handled by the software modules of the invention while in the second position DTMF codes generated by such telephone 110 are directed to the wired telephone network.

The selector module 311 includes a DTMF detector, a ringer, and a three position switch which is DTMF commanded providing normal VoIP, PSTN, and Conference calling. Protection circuitry may also be found in the selector module 311.

The switch does not necessarily refer to a hardware switch hand operated by a user. The switch system may be controlled by an application program, by DTMF codes generated by the telephone, or it may be automatic. For example, in an alternative embodiment, the switch may select the appropriate route for telephone service based upon the callee telephone number entered by the user. A database or short dialing codes may be provided with telephone numbers associated with a preferred route of communications: VoIP or PSTN. Such dialing codes may be short codes having only two or three digits or may be full length numbers, speed dial entries of the telephone, etc.

The DTMF algorithm may be explained by comparing the way humans hear different frequencies of sound. Human perceptions hear a noise the sound is split into frequencies by a mechanical means inside the listener's ears. This process can also be done by mathematical computation in the computer 115 by means of a widely known algorithm and computation called Fast Fourier Transform, or the FFT. The sound card 322 in the computer 115 has a digitizer. It makes very fast measurements of an analog sound and converts it in real time to a series of digital numbers called a sampling. The invention's DTMF detector uses the sound sampling of the sound card 322 to detect and recognize the DTMF unique sound frequency out of the entire sound stream it receives. This is possible because each DTMF digit is formed from two pre-defined distinctive frequencies.

The flow chart in Table 1 explains the process (tN represent the time slots when a given operation is performed).

TABLE 1

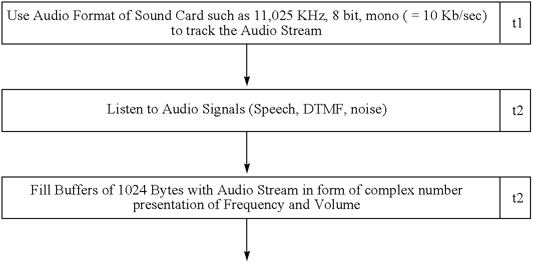

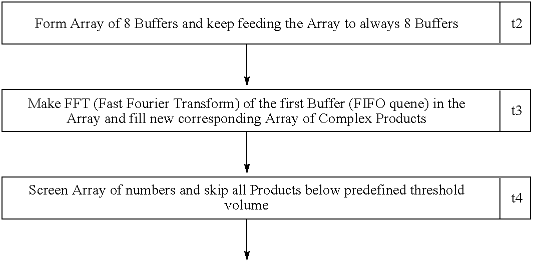

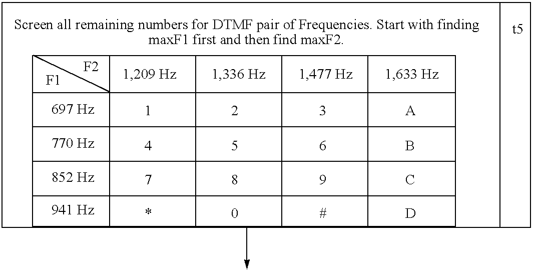

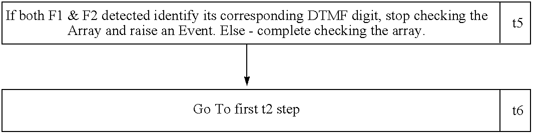

DTMF pair A, B, C, D (F2=1633 Hz) do not exist in normal phones as available keys. One embodiment program may use this option for further special commands with dedicated keypad for remote commands like operate a telecommanded unit such as a camera or another appliance, open a discrete device such as a faucet or a door, listen, record, play, and similar remote functions.

An RJ-11 jack or any other standard telephone jack, on a base for the cordless or regular phone 110, is attached to the RJ-11 plug 112 leading from the Internet chat cord's circuitry 111. A first tip 312 and a first ring 313 receive electrical current from a power regulator module 314. The purpose of the power regulator module 314 is to compensate using DC voltage as needed by some phone devices 110 that may need up to 5 volts current in order to operate properly. Input electrical current is 5V from the computer's universal serial bus port or PS/2 port 113. Output is ˜5V regulated from the noise input. This module also blocks any signal from the first ring 312 and first tip 313 to enter the PC via the ports.

Connected to the first tip 312 and first ring 313 is an Electrical Magnetic Interference/Radio Frequency Interference (EMI/RFI) suppression module 315 that protects the Internet chat cord and the PC circuitry from EMI/RFI noise to the environment in both radiated and conducted modes.

Attached to the EMI/RFI suppression module 315 is a power limit module 316. The power limit module 316 purpose is to protect the Internet chat cord 111 and PC 115 circuitry from any voltage above 6.5Vdc. Higher voltage, including pure DC of any polarity and AC, can be generated from external spikes or a wrong connection by the user. A second tip 317 and second ring 318 follows the power limit module 316.

Linked to the second tip 317 and second ring 318 is a coupler module 323. The two-wires, second tip 317 and second ring 318, are used for both transmit and receive at the same time (full duplex). The audio signal is the differential voltage between second tip 317 and second ring 318 and is within the frequency range of 300 Hz-4 KHz.

The coupler module 323 is an electronic circuit that splits a bi-directional signal from the second tip 317 and second ring 318 lines to two pairs of unidirectional signals on the speaker and microphone on the sound card 322 residing in the computer 115. In other words, the outgoing audio signal from the phone handset 110 is directed to the pair of the microphone and is blocked from passing into the pair of the speakers. Similarly, the outgoing audio signal from the speaker is directed to the pair of second tip 317 and second ring 318 and is blocked from passing into the pair of the microphone. The second tip 317 and second ring 318 signals are superpositions of audio receive and audio transmits signals on top of a DC signal of 5V, while the microphone and speakers are audio signals only.

The coupler module's electronic circuit follows the formula:
Vmic=Vr-t−Vspk−Vdc and Vr-t=Vring−Vtip=Vrx+Vtx+Vdc

Where:
Vtx=Vspeaker=Vspk
Vrx=Vmicrophone=Vmic
Vdc=5V

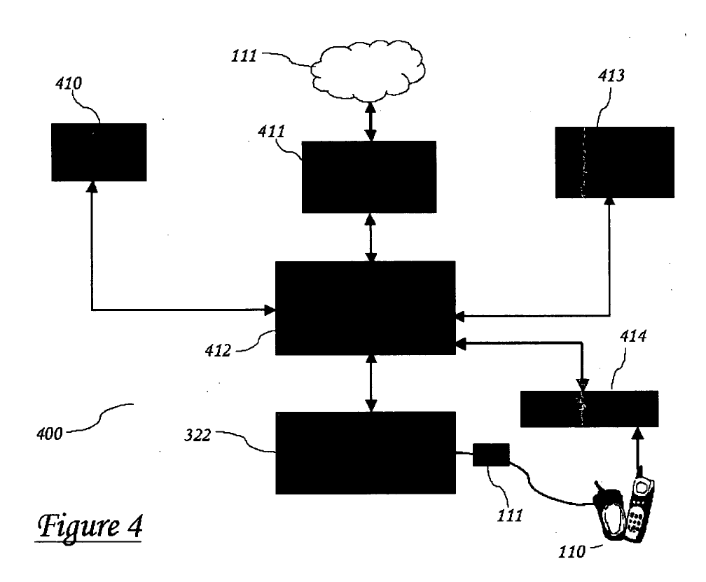

Block diagram FIG. 4 indicates software participation between an Operating System (OS) of a PC 115 and an invention installation software as a voice signal may travel to the Internet. The cordless or regular phone 110 is shown connected with the RJ-11 plug 112 from the electronic interface unit (Internet chat cord) 111. The electronic interface unit (Internet chat cord) 111 is attached to the sound card 322. A Digital Tone Multi-Frequency (DTMF) program 414, which allows use of two simultaneous voice-band tones for dialing (such as touch-tone), correspond with a software application 412, provided by the invention. The invention installation application program software 412 may be loaded or installed onto the host personal computer 115 where it may coordinate with the operating system (OS) 410 of the host PC 115.

An application program 412 may be configured to attach the internet connected PC 115 to the cordless phone 110 and to exclusively control the communications and dialing from the cordless phone 110 via the PC 115. The application program 412 may monitor the communications port to open a duplex voice connection of the remote device to the Internet 116. Upon detecting a connection request of the remote device to a selected address (such as Internet Protocol address or PSTN addressing scheme). The application program 412 searches and connects to the appropriate address or prompts the user that the connection is not available.

In a Local Area Network the electronic interface unit (Internet chat cord) 111 may be shared among other PC resources 413. The application program is installation software 412 which checks the connections and installs a resident dialer which enables a user to place a call. Internet chat cord passes the phone's DTMF tones to the computer, and the phone application program 412 translates the DTMF 414 tones given for the addressee, from cordless or regular phone 110, into the appropriate twelve digit Internet Protocol addressing scheme allowing a change from the analog voice signal to a digital signal (so the VoIP services may recognize it) via an Internet connection 411 and into the Internet cloud 116.

An alternative embodiment to the invention may include conferencing ability between the user with an individual connected via Voice over Internet Protocol as well as an individual connected via PSTN/POTS, simultaneously.

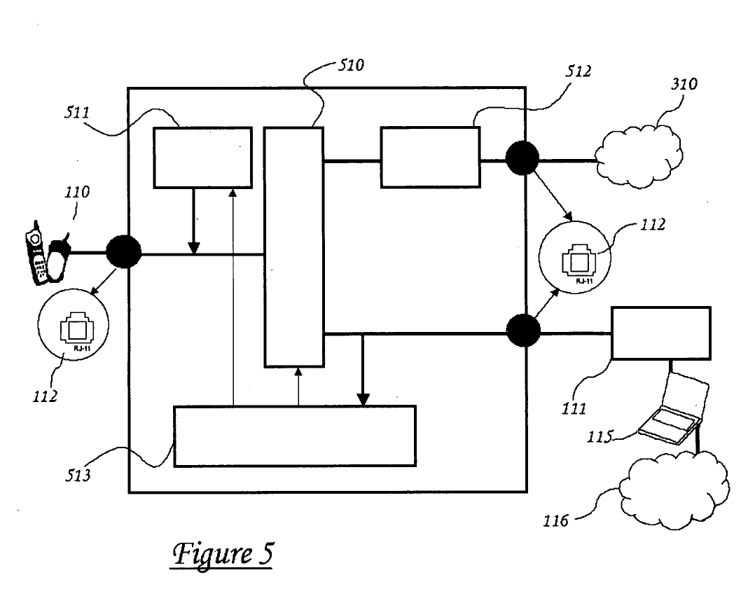

An expanded view of the Selector Module embodiment of the Internet chat cord circuitry can be seen in FIG. 5. The selector module 311 performs three functions:
1. Provides three selection modes that may be commanded via DTMF. They include PSTN, VoIP and Conferencing.
2. Provides Ring tone for entering call (PSTN or VoIP).
3. Provides a protection circuit from and to the PSTN line.

The cordless telephone or regular phone 110 is connected via the RJ-11 plug 112 to the selector module 311. Within the selector module 311 the cordless telephone or regular phone 110 is linked to the ring generator circuit 511. The phone ring signal is an AC signal of 70-90 V and with a given frequency such as 20 Hz. The signal is trapezoidal or sinusoidal and is generated from the 5 Vdc entering the selector module 311 from the Internet chat cord 111. During a PC-to-PC call initiation, a DTMF command produced by the caller's Internet chat cord application 412 is sent via the receiver's Internet chat cord application 412 to the selector module 311, and in turn passes internally to the ring generator 511 causing it to produce a ring signal on the telephone 110.

The ring generator 511 is linked to the selector circuit 510. The selector circuit 510 includes a three position electronic switch allowing normal VoIP, PSTN, and Conferencing. The switch is commanded by the DTMF 414 of the Internet chat cord application 412 via an internal DTMF detector circuit 513.

Dual Tone Multiple Frequency (DTMF) is an aural, two frequency, tone associated with each digit on a telephone keypad. The DTMF detector circuit 513 includes a DTMF decoder chip. The DTMF decoder chip functions to detect electronically a DTMF command from the Internet chat cord application 412 and to send a control command to the ring generator 511 and/or to the selector circuit 510. Therefore, the DTMF detector circuit 513 relays the DTMF commands of the application 412 to the internal circuitry of the selector module 311 unidirectional.

Linked to the selector circuit 510 is the protection circuit which is implemented to prevent the external PSTN signals, spikes and ring power from interfering with or damaging the selector module 510 circuitry, the Internet chat cord 111, and the PC 115.

As has already been noted, the selector module embodiment is one which utilizes the 5Vdc output of the USB or PS2 port, unlike other embodiments which may dispose of the USB or PS2 port power source.

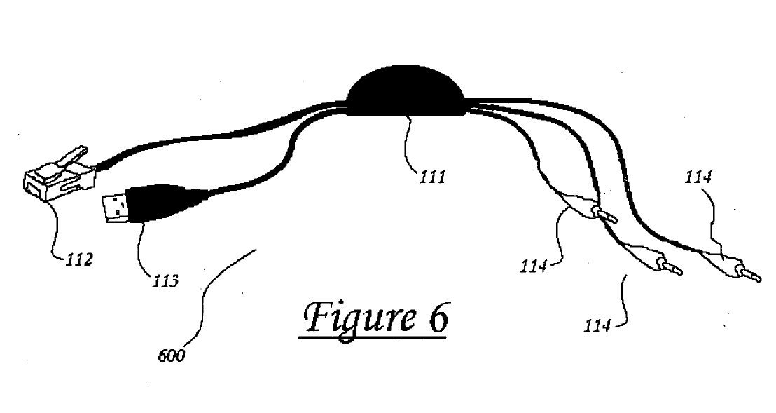

The electronic interface unit (Internet chat cord) 111 is shown in FIG. 6. The cordless or regular phone 110 is attached to the RJ-11 jack 112 leading from the Internet chat cord's circuitry 111. The universal serial bus plug 113 which provides up to 5V of current to the cordless or regular phone 110 is attached to the Internet chat cord's circuitry 111. Alternative embodiments may provide a PS/2 plug accommodating computers with a PS/2 jack. Leading from the Internet chat cord's circuitry 111 are input/output mini-jacks 114/611/612. They include input/output mini-jacks plugs 114 for speakers output to be connected to the personal computer 115, a female mini-jack 611 to let loud speakers to be plugged in order to enable the user to receive and hear a ringtone of an entering VoIP call or if a user may want to play and hear other sound on the PC 115 during routine use as well as input/output mini-jacks plugs 612 for microphone input to be connected to the personal computer 115.

Table 2 offers a step by step process of the dialing management that occurs from a phone 110 to the PC 115 and out to the Internet 116 in cooperation with the invention software 412 and the personal computer operating system.

TABLE 2

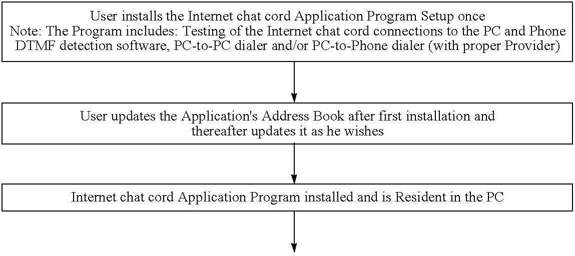

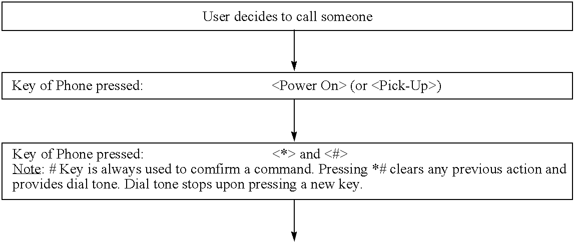

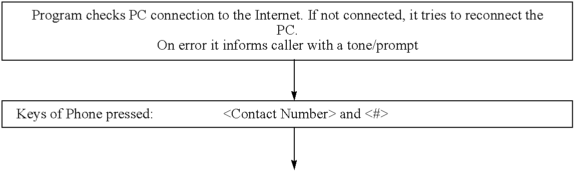

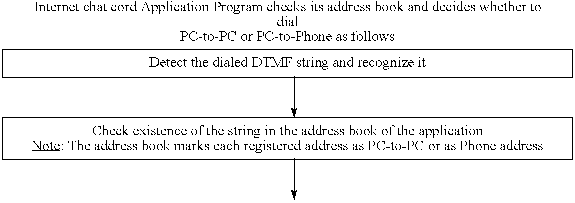

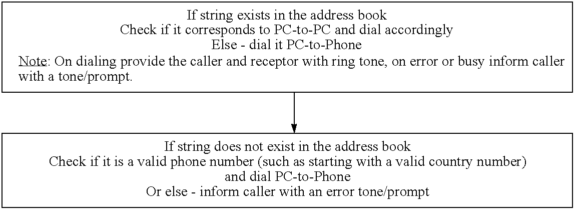

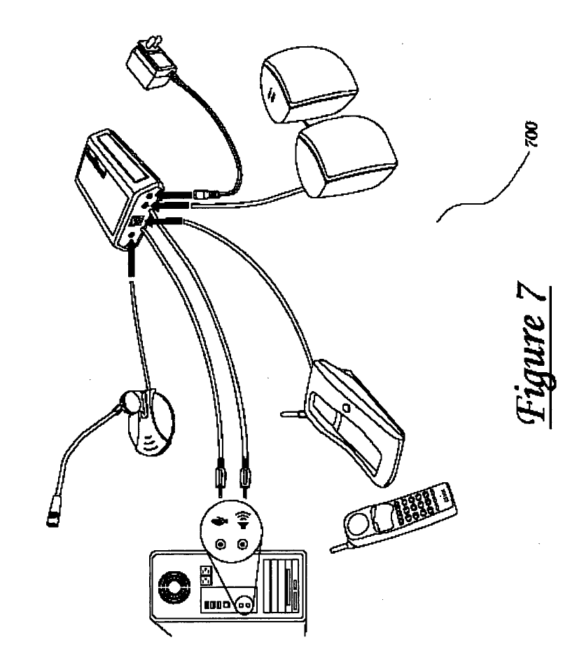

Prior art may be seen in FIG. 7. PhoneBridge is a device that utilizes a PC 115 to connect a telephone for making VoIP calls. Neither does PhoneBridge enables remote VoIP dialing through the phone nor does it have any detection of DTMF. Unlike the present Internet chat cord and software device invention, Phonebridge may pass the phone's DTMF tones to the computer, but none of the computer's services, including especially VoIP, recognize the tones as commands. The Internet chat cord 111 has an operating software, which enables complete detection and understanding of the DTMF tones of the phone 110. Hence, only with an electronic interface unit (Internet chat cord) and its software the telephone can send and receive commands (dial, address book, prompts, ring, record, play, switch PSTN/VoIP). Phonebridge uses external mains power (110/220VAC) unlike the present invention which is independent and using only the PC resources. Phonebridge doesn't provide automatic switching and even not manual to the PSTN line.

Identified in the diagram is a PhoneBridge 710 box, a microphone 711, a computer rear view 115, input/output jacks 714 of the computer 115 and the corresponding input/output plugs from the PhoneBridge. Prior art incorporates a cordless phone 110 and separate speakers 713. The PhoneBridge receives its electrical current from a standard 110V outlet via a power supply plug 712, while the Internet chat cord 111 receives 5V electrical power from the USB (or the optional PS2) connection 113 to the computer 115 to power most types of cordless phones and all types of line phones, without need to hook them to an RJ-11 wall socket.

The expanded DTMF pairs ability of the present invention (which maydo not exist in today's phone-sets) may also be utilized to perform special remote commands like operate a telecommanded unit such as a camera or an appliance, open a discrete device such as a faucet or a door, listen, record, play, and similar remote functions. The present invention may also be utilized to provide voice/audio input/output to the computer by means of the telephone keys (or a dedicated similar keys apparatus) for purposes other than VoIP. For example, voice recognition software is one meta-embodiment of the present invention which in turn allows voice activated operating system use, voice based word processing, vocal gaming, and similar voice based applications. Another such meta-embodiment is the use of the present invention to input audio signals to audio recording programs. While normally the use of a telephone (with inherent frequency restraints of the present technology) is an unlikely choice of microphone, in the future, high quality telephony may allow remote recording of voice audio (i.e. for musical purposes, for automatic messaging and so on) via the use of the present invention.

The disclosure is provided to allow practice of the invention by those skilled in the art without undue experimentation, including the best mode presently contemplated and the presently preferred embodiment. Nothing in this disclosure is to be taken to limit the scope of the invention, which is susceptible to numerous alterations, equivalents and substitutions without departing from the scope and spirit of the invention. The scope of the invention is to be understood from the claims accompanying the corresponding utility application to be filed at a later date.

1. A computer audio input/output device comprising:
a personal computer having an operating system and a full duplex voice sound card;
the sound card having a first standard mini-jack input, and having a second standard mini-jack output;
a first software device respectively providing audio input and output to the respective first and second jacks;
an electronic interface unit having, at least two standard mini-jack plugs, and a standard telephone jack plug;
a second software device responsive to inputs commanded by the telephone via the electronic interface device;
a signal conversion circuit connecting a voice signal from the standard telephone jack to the input mini-jack, and connecting an audio signal from the output mini-jack to the standard telephone jack plug.

2. A Voice over Internet Protocol device comprising:
a personal computer having an operating system, Serial Bus port, an internet connection, and a full duplex voice sound card;
the sound card having a first standard mini-jack input, and having a second standard mini-jack output;
a first software device respectively providing audio input and output to the respective first and second jacks;
a second software device having a Voice over Internet Protocol production module to the Internet via the Internet connection, and a Voice over Internet Protocol reception module from the Internet via the Internet connection;
an electronic interface unit having, at least two standard mini-jack plugs, and a standard telephone jack plug;
a signal conversion circuit connecting a voice signal from the standard telephone jack to the input mini-jack, and connecting an audio signal from the output mini-jack to the standard telephone jack plug.

3. The Voice over Internet Protocol device of claim 2 further comprising a Serial Bus port such as USB/PS2 plug and the operative connection further comprising a power conversion circuit connecting an electrical power signal from the computer's Serial Bus port to the standard telephone jack plug.

4. The Voice over Internet Protocol device of claim 2 further comprising an application program;
the application program having a software database of VoIP addresses and telephone numbers,
the application program having a communications port monitoring module able to open a duplex voice over internet protocol connection to the internet and able to open a duplex voice connection to a Public Switched Telephone Network,
the application program having a detection module able to process a DTMF connection request of a device attached to the standard telephone jack to a selected address.

5. The Voice over Internet Protocol device of claim 2 wherein the electronic interface unit further comprises an Electrical Magnetic Interference/Radio Frequency Interference (EMI/RFI) suppression module that protects the interface unit and Personal Computer from EMI/RFI noise from the environment in both radiated and conducted modes.

6. The Voice over Internet Protocol device of claim 2 wherein the electronic interface unit further comprises a power limit module;
a power limit module providing protection to the electronic interface unit and personal computer from any voltage above 6.5 Vdc.

7. The Voice over Internet Protocol device of claim 2 wherein the electronic interface unit further comprises a coupler module;
a coupler module providing a bidirectional signal split of unidirectional signals of the speaker and microphone jacks of the sound card of the computer,
the coupler module's electronic circuit following the formula,
Vmic=Vr-t−Vspk−Vdc and Vr-t=Vring−Vtip=Vrx+Vtx+Vdc
wherein;
Vtx=Vspeaker=Vspk,
Vrx=Vmicrophone=Vmic,
Vdc=5Vdc.

8. The Voice over Internet Protocol device of claim 2 wherein the electronic interface module further comprises a selector module;
the selector module including a DTMF detector, a ringer, and a three position switch,
wherein in the first position, the standard telephone jack is connected to the computer for VoIP communications; and
wherein in the second position, the standard telephone jack is connected to a PSTN service; and
wherein in the third position, the standard telephone jack is connected to both the PSTN service and the computer for conference calling spanning both PSTN service and VoIP service.

9. The Voice over Internet Protocol device of claim 8, wherein the switch further comprises a DTMF detector able to receive DTMF codes from the standard telephone jack and alter the position of the switch in response to such DTMF codes.

10. The Voice over Internet Protocol device of claim 9, wherein the selector module further includes a database of telephone numbers in the database, indicating whether VoIP or PSTN is the preferred communication route for a given telephone number.

11. The Voice over Internet Protocol device of claim 2 further comprising a POTS telephone (typically with 600 ohms impedance).

12. The Voice over Internet Protocol device of claim 3, wherein a detection module carries out the following steps:
1) Use sound card to track audio stream input from the electronic interface unit;
2) Form a first array of buffers with the audio stream in the form of a complex number representing Frequency and Volume;
3) Perform a Fast Fourier Transform on each buffer in the first array and use the product to fill a corresponding buffer in a second array;
4) Select products at least equal to a predefined threshold value;
5) Screen the selected products for two maximum values;
6) Associate the two maximum product values with the DTMF digit corresponding to the frequency combination of the two maximum product values, repeating steps 5 and 6 until such association is made;
7) Raise an event to the application program.

13. A computer system comprising:
A PC having a full duplex voice card and having a USB or PS2 port and an operating system and a communication port;
an operative physical connection from the PC communication port to a cordless telephone;
an application program within such PC having a module to provide operative communication to the cordless telephone, and having a module to control communications and dialing of the telephone;
a computer network connection;
wherein the application program has a monitoring module responsive upon receiving a communication request from the telephone to open a duplex voice connection of the telephone to the network.

14. The computer system of claim 13, wherein the operative physical connection further comprises a standard telephone jack at one end and a microphone jack and a speaker jack at the other end, the telephone being plugged into the standard POTS telephone jack and the microphone and speaker jacks being plugged into the computer, the respective jacks being in a tuned connection.

15. The computer system of claim 13, wherein the monitoring module further comprises a database of VoIP and PSTN addresses, and wherein the monitoring module further comprises a DTMF detection module, the database being responsive to the DTMF detection module.

16. The computer system of claim 13, wherein the application program further comprises a network monitoring module able to monitor the network connection and indicate reception of an incoming VoIP communication from the network, the indication being made at one member selected from the group consisting of: the PC, the telephone, and combinations thereof.

17. The computer system of claim 13, wherein the application program further comprises a telephone service module providing at least one member selected from the group consisting of: prompting of callers, caller identification, message recording, ring status indicators, busy status indicators, no signal status indicators, error indicators, and combinations thereof.

18. The computer system of claim 15, wherein the application program further comprises a control module responsive to the DTMF detection module, the application program functioning being responsive to the control module.

19. The computer system of claim 15, wherein the DTMF detection module is further responsive to DTMF commands in which one of the DTMF frequencies is 1633 Hz.

20. The computer system of claim 13, wherein the operative connection further comprises:
an operative connection to a PSTN telephone network, the operative connection having parallel connections to the PC and to the PSTN telephone network.
